(19) United States
(12) Patent Application Publication
(10) Pub. No.: US 2022/0050929 A1
(43) Pub. Date: Feb. 17, 2022

(54) SECURE FORECAST SYSTEM TO GENERATE FORECASTS THAT PREVENT UNAUTHORIZED DATA MODIFICATION AND INCLUDES REPORTS ON A TARGET LEVEL OF INTEGRITY TRACEABLE TO HIGH INTEGRITY DATA SOURCES

(71) Applicant: Terence Malcolm Kades, CHEYENNE, WY (US)

(72) Inventor: Terence Malcolm Kades, CHEYENNE, WY (US)

(21) Appl. No.: 17/402,310

(22) Filed: Aug. 13, 2021

Related U.S. Application Data
(60) Provisional application No. 63/065,320, filed on Aug. 13, 2020.

(51) Int. Cl. G06F 21/64; G06F 21/62; H04L 9/32

(52) U.S. Cl. CPC G06F 21/64; H04L 2209/38; H04L 9/3263; G06F 21/62

(57) ABSTRACT

A driver-based high-integrity forecast source attributing system with blockchain technology that through its methods and user interface screens, categorizes scenarios into high-integrity and custom-source sections and provides a set desired-level of high-integrity accreditation in the forecast definition. The method incorporates the use of a weighting system for scenarios and the driver-item pairs within a scenario that can be applied within the forecast algorithm and generates a high integrity forecast with a certificate of accreditation which together with a link to access is encrypted. The system provides method for making available scenarios and drivers that are both high-integrity and custom-source and can store endorsements data source type. The system also provides a method and user interfaces for a recipient of a forecast to perform what-if modeling of the forecast and stress test the values and the weights in the drivers and view their effect on the outcome of the forecast.

### BACKGROUND OF THE INVENTION

Currently, forecast systems and methods lack processes and methods to ensures the forecast has a specific certainty about its data integrity and ensure that the underlying data the forecast source remains intact and unaltered so that the forecast can be relied-on. It would be of value if a forecast had credentials supporting its reliability that was backup by evidence. Such a forecast could be relied to make decisions based in part on the quality and procedures of the underlying data and calculations. A forecast that is certified as robust in terms of security that protects it from alteration, and reliable in terms of the professional trustworthiness and likely accuracy, can impart confidence to the decisions based upon the forecast.

Forecasts are constructed for a variety of purposes and come in various types.

What is needed in the forecasting system that can provide a forecast that is traceable back to high integrity source data and can indicate how much of the forecast can be attributed to high integrity sources free from alteration so that decisions to be made that are based on the forecast can be done with confidence.

### SUMMARY OF THE INVENTION

A secure system with a source attributing system to generate forecast numbers attributed to a known source that prevents unauthorized modification of data, and prevents piracy of the high integrity data that prevent privacy violations and only allows authorized use of the data.

The invention is founded in the methods, processes and user interfaces herein described that ultimately provide an encrypted forecast that is traceable to a data source and where the integrity of the forecast including methods, formulas and anti-hacking security devices are protected from unauthorized access by distributed ledger technology from being manipulated and corrupted both before the forecast has been generated and after it has been generated.

The terms “high integrity” used herein is related to the forecast system being a forecast source attributing system to generate a high integrity forecast. The term “custom source” refers to drivers that are do not meet the requirements of high integrity and in the forecast source attributing system.

The first item is the method, process and user interface of an encrypted accreditation certification for a generated forecast that will ensure the integrity and disallow tampering of a forecast created in the forecast source attributing system.

The second item is the method and user interface to create and assemble and bundle attributed source drivers into a packaged probabilistic traceable to a scenario being a verifiable and traceable source scenario that can be applied via the forecasting algorithms to the baseline item data to generate a forecast, where a user interface design provides for search and select appropriate drivers for a required forecast for a particular purpose or area of interest.

The third item relates to user interface screens where the drivers are characterized and sectioned off into integrity buckets, with each bucket having unique user interface and standards of integrity control. The forecast source attributing system provides a map screen to map the drivers of a particular data bucket or other framework bucket separately to each baseline item to be projected in the forecast by way of a weight assigned to the their driver-item pair, and the system provides a user interface that links to additional screens, to manually change the baseline weights for each driver to baseline item within a specific period of the forecast and these together being the baseline or customizable period weights, weights of a first-data-bucket drivers' and weights of the second-data-bucket drivers section, and values of each driver in each forecasting period, and values of each baseline item to be forecast period will be used in the algorithm to generate a forecast with attribution to source.

Preventing malicious manipulation of high integrity data is important for a forecast to be relied on.

The forecast source attributing system allows “what-if” modelling of a forecast via a series of encrypted links and components of the previously generated forecast.

### BRIEF DESCRIPTION OF THE DRAWINGS

FIG. 1 illustrates an example of the encrypted forecast source attributing system and module components;

FIG. 2 illustrates the interconnecting components on both the input, processing, calculation and output aspects illustrating a distributed system including a plurality of computers with security encryption built-into the networking and the forecasting software;

FIG. 3 illustrates the process to create a scenario from the drivers in the high integrity forecast source attributing system;

FIG. 4 is a high-level illustration of the activity process flow through the encrypted high integrity forecast source attributing system structure;

FIG. 5 illustrates a more detailed view of the driver selection and scenario creation process to the creation of a certified forecast;

FIG. 6 illustrates the process to formulate the required selections to generate an high integrity forecast;

FIG. 7 illustrates the first step in the creation of a drivers-to-items to be forecast map;

FIG. 8A illustrates the screen fields inputs and weights in the Set baseline weights of driver-item pair in the map creation process as related to high integrity drivers;

FIG. 8B illustrates the fields with slightly different options for custom source drivers;

FIG. 9 A illustrates the drivers baseline with detailed period weight editing options to create a new baseline;

FIG. 9B illustrates the drivers baseline display in the custom source detailed weight table.

FIG. 10A is an illustrates of the fields and information on a certificate of a generated high integrity forecast;

FIG. 10B is a continuation of FIG. 11A showing the breakout of high integrity and custom source drivers and their weights in the forecast as well as encryption of the forecast information and link;

FIG. 11 illustrates setup to generate an email letter with encrypted link to retrieve the certified high integrity forecast and an example of the text of the letter/mail that will be sent via the forecast source attributing system forecast source attributing system to the receiver.

FIG. 12 illustrates the driver weight and modeling of “what-if” type options that the intended recipient of a forecast may perform.

FIG. 13 illustrates the process steps for variance analysis of different forecast scenarios and the secure encrypted link to open channel for stakeholder to discuss the forecasts and variances.

FIG. 14 illustrates how multiple scenarios and driver-item maps can be incorporated into a single forecast.

FIG. 15 illustrates the user interface method to view the impact of weights in forcing certain drivers to be in the bucket of high integrity data sources.

FIG. 16 illustrates the unauthorized modification process and the normal process of the high integrity and custom source data process.

### DESCRIPTION OF EMBODIMENTS

The claims herein relate inter alia, to certain features and user interfaces to a forecast source attributing system that is designed to generate medium to long-term forecasts (usually 6 to 24 month forecast range) and which forecast source attributing system is based on a method that in addition to methods of encryption, uses drivers and scenarios and numerical weights to map these to items that are to be projected in a forecast in the manner that the forecast generated becomes a high integrity forecast that is encrypted and certified as reliable.

Integrity in this document means internal consistency or lack of corruption in the electronic source data. For example, free from unauthorized modification. If a report is above a integrity threshold then the forecast may be deemed a high integrity forecast or a certified forecast or accredited forecast meaning also that the forecast that is additionally certified as robust in terms of security that protects it from alteration.

The features, user interfaces, methods and processes to generate a high integrity forecast, apply encryption to it, and then also securely deliver it or an encrypted link to access it. Such forecast can be certified by the provider of the forecast source attributing system, as a trustworthy and reliable forecast with evidence of such by a certificate accompanying the forecast which uses processes to generate an high integrity forecast. To access the report attached to the forecast the encrypted link may require the user to prove who they are (authenticate) and this can prevent unauthorized disclosure of the report and the forecast.

The driver data traceability and encryption is to provide integrity to ensure that the items that need to be protected and unauthorized modification such as the formulas, driver data, baseline data, weighting, accreditation level setting is maintained without unauthorized alteration. An element comprising the forecast cannot be altered or compromised either within the process of generating the forecast and in keeping the original integrity of the resultant forecast itself intact and unaltered.

The benefit of integrity within the forecast source attributing system and to protecting the forecast itself is one of trustworthiness for a person who will make decisions based on the forecast data. Knowing that the forecast source attributing system has built-in encryption security with verifiable audit trail, and that the information attached to the forecast certificate is the original high integrity data and unable to be altered due to a strong encryption method will add value to the reliability and usefulness of the forecast.

The said certificate of accreditation will list information associated with and underpinning the forecast including the names of the providers of the drivers and scenarios used in the high integrity forecast. These providers would typically be data source type experts skilled and experienced in the forces that affect the data source type wherein the generated high integrity forecast resides or is based. All the above after having followed an actuary vetted and high integrity forecasting process and method and which is incorporated into the design, methods and functioning of the invention.

The invention incorporates certain mathematical constructs and also provides for customized mathematical calculations and relationships.

The forecast source attributing system components claimed herein or any part thereof may be provided on different technology platforms as installable software application, a server application, a Cloud-based application and an online service e.g. web service, Cloud service, white-label product/service and tools, and any other electronically accessible technology and computer operating system with the capability to interface with other computers and store, calculate, manipulate and send and receive data.

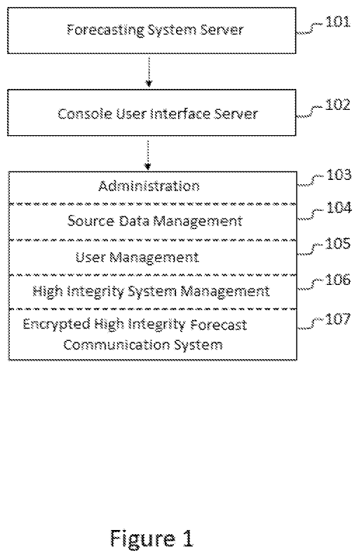

FIG. 1 illustrates the primary architecture components of the high integrity driver-based forecast source attributing system. The primary forecasting server 1001 hosts and provides the computing power, methods and algorithms and other sub-components such as the Console user interface server 102 which also provides the system user interfaces and management components being the Partner administration 103 and the sub-components therein being the modules that provide services for client data management 104, system management 105, accreditation system management 106, and the encrypted high integrity forecast communication system 107.

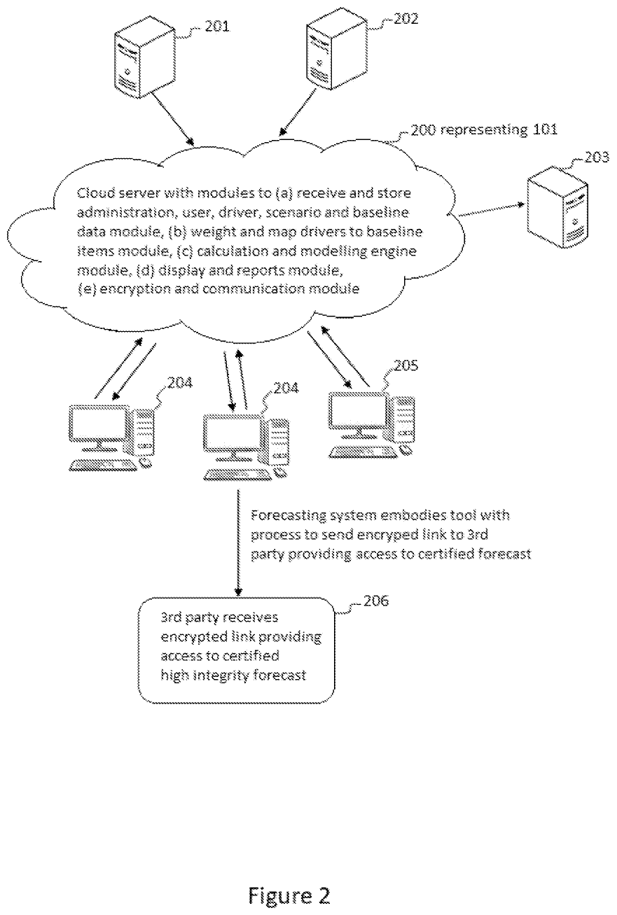

FIG. 2 illustrates a computer server 200 (the same as Forecast source attributing system Server numbered 101 in FIG. 1) which is connected to receive, store and disseminate forecast driver data 201 and scenario data 202, send data to 203, and to send and receive raw and processed data 204 and 205, and to send and encrypted link 206 to a third party who has an interest in the generated forecast.

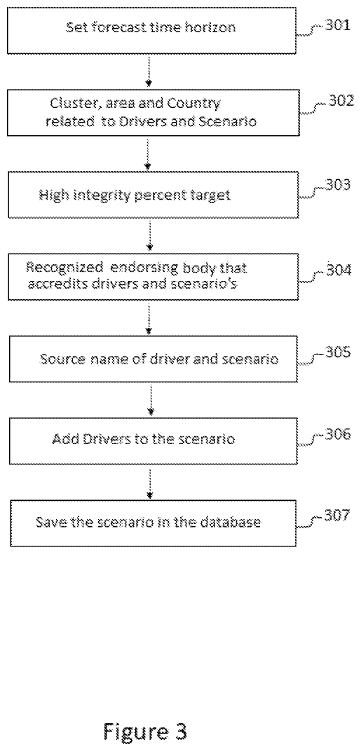

FIG. 3 illustrates the process whereby a scenario is created. The forecast source attributing system presents a series of filtering selections, beginning with first selecting the time horizon 301 of the forecast, then the data source type name and geographic location of state or province and country 302, then the target integrity percent level of accreditation for the scenario 303, thereafter the endorser of the drivers within the scenario and the scenario itself 304, name of supplier of the scenario 305, after the selections made in steps 301-305 viewing the list of drivers and selecting to add to the scenario 306 and then saving the scenario 307 with the selected drivers inside.

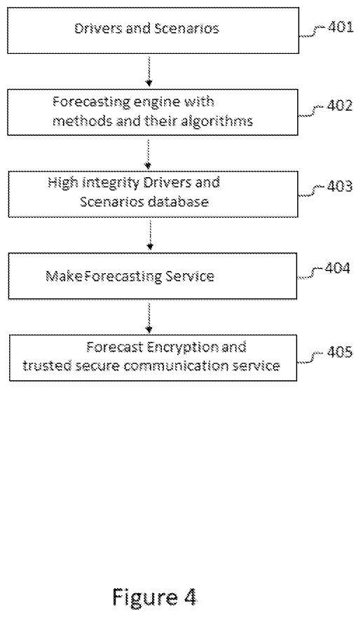

FIG. 4 Illustrates the process where drivers and scenarios 401 are fed into the forecast source attributing system through a high integrity data provider role. The drivers and scenarios are further filtered within the forecasting engine 402 to tag the high integrity drivers and scenarios so that these high integrity items are made available to view and select 403 and via the forecasting service 404, generate an encrypted link to the high integrity forecast 405 to send to a stakeholder to assess for further action.

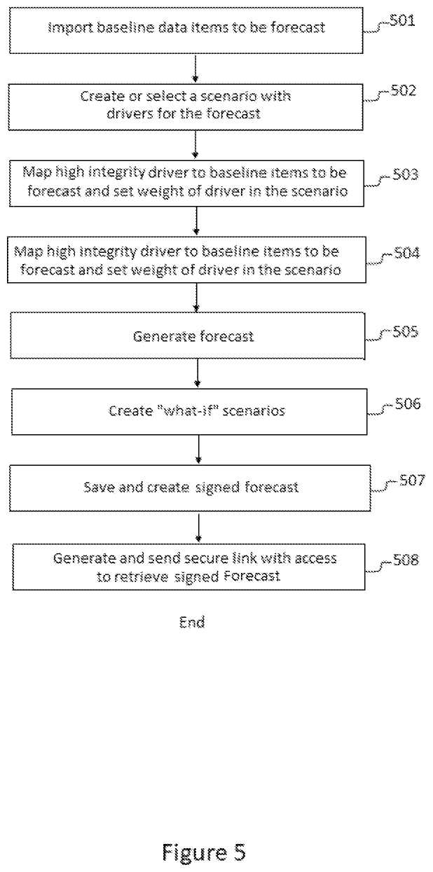

FIG. 5 illustrates the delineation for high integrity and custom source driver and scenario “buckets” and process where baseline items to be forecast 501 are imported into the forecast source attributing system, then used to either create or select an existing scenario 502 that will applied to the baseline data by means of a map process 503 where an item to be forecast is mapped to an high integrity driver via a weight which links them, and once the high integrity driver-item pairs and weights are completed, then mapping the custom source drivers 504 and assign weight of item to each custom source driver is processed in similar fashion to the 503 process of high integrity drivers. The forecast source attributing system, can generate the high integrity forecast 505, which can be cloned 506, with the cloned version being available for “what-if” modelling 507 by altering applicable variables provided via the high integrity forecast source attributing system, and both the original and cloned forecast can be saved together with a secure and encrypted certification 508 that displays and lists all the pertinent drivers and variables that impact the forecast. The final step in the process instructs the forecast source attributing system to generate and send a secure encrypted link that will give viewing and “what-if” modelling access to the specific named receiver of the encrypted link.

High integrity sources can have high integrity numbers for time periods, for example where time period is a month or quarter. Custom source can have custom numbers for time periods.

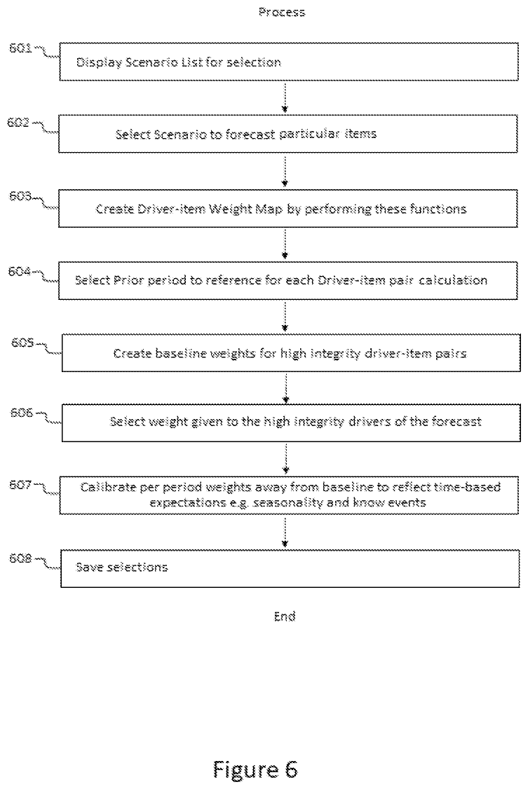

FIG. 6 illustrates the process of mapping items to drivers and ascribing weights to each. The list of scenarios 601 is displayed, whereupon the selection of a scenario 602 from the list that will be used to create the forecast for a particular baseline set of data to be forecast. After selecting a scenario, a new window displays to begin the driver-item weight map 603, where the forecast source attributing system provides options on how the baseline data prior period will be referenced 604 for each driver-item pair, and then proceed to create the baseline weight initially for the high integrity drivers for each driver-item pair 605, and then select the target integrity percent level that high integrity drivers will dominate the result of the forecast to be generated 606. The baseline weight values apply to all periods in the forecast and an operator may change individual periods data 607 to better reflect seasonality and other anticipated expectancies, and then save 608 the above to be applied to generate a forecast at a later time.

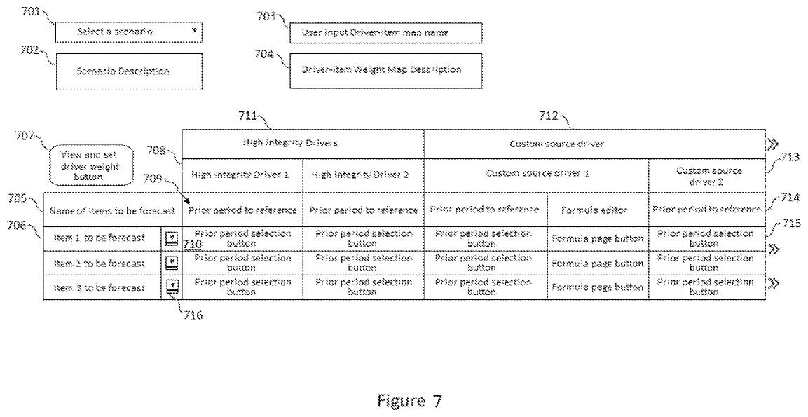

FIG. 7 illustrates the fields in a window when setting-up the initial selections of a driver map. A scenario is the starting point of what is displayed in this window 701 and information about each active scenario is shown in the description 702, Once a scenario is selected then the operator will type-in a name 703 for the map and a description 704. The first column from the left side of the table 705 are the names of baseline items to be forecast with each item 706 in a row on the table. The next column section in the table displays the high integrity drivers 711 in the driver-item map and the first high integrity driver 708. The intersection of the item row 706 and the first high integrity driver 710 is the prior period to reference selector where the forecast source attributing system provides for the selection from immediate prior month, or same month in the previous year, or a two or three or 4 month average of the previous year and this selection will determine a point of reference in how the forecast will be calculated. On the custom source driver column section 712, the custom source driver 713 is displayed but the custom source driver also provides the option to make use of a formula editor 714 giving the option to proceed to the formula page 715 and create a custom formula to apply when the forecast source attributing system generates the forecast. The button at 707 to view and set driver weight button will spawn a new window where weights can be selected and set for later application to a forecast.

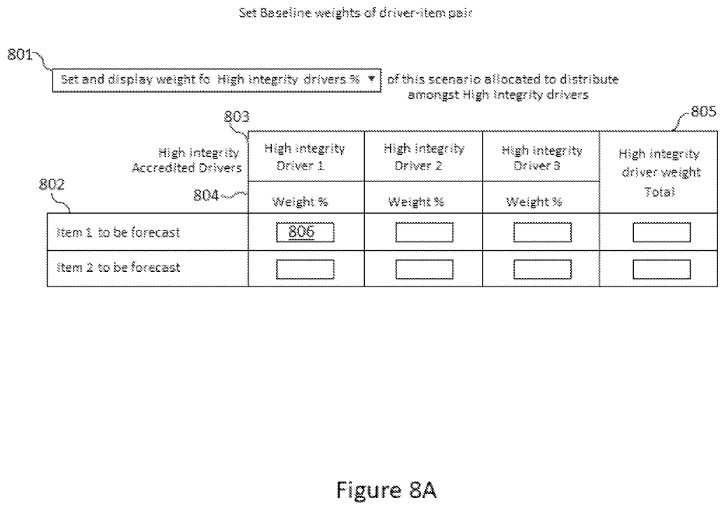

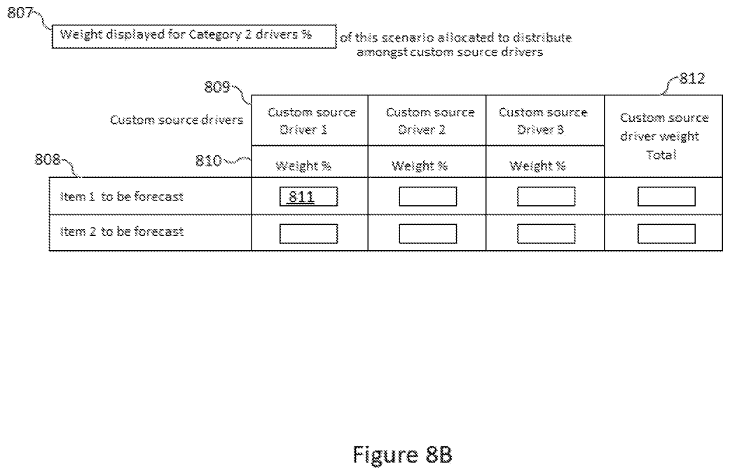

FIG. 8A illustrates the mechanisms to set baseline weights of driver-item pairs. The weight that will be afforded to high integrity drivers in the forecast is selected 801, and the baseline item names to be forecast 802 are displayed in the rows, and the names of each high integrity driver in the columns 803. The baseline weight for each driver-item pair 804 is set by the operator and the total for all high integrity drivers relating to the row must meet a weighting method which is to total to 1 indicating 100%. After this process, the forecast source attributing system will have the required baseline settings to generate an high integrity forecast with all the weights necessary to do so.

FIG. 8B illustrates the mechanisms to set baseline weights of driver-item pairs for custom source drivers. The weight that will be applied to custom source drivers is merely displayed and cannot be changed because it reflects the remaining balance after deducting the weight amount attributed to high integrity drivers. To qualify as a high integrity forecast, the high integrity drivers must dominate in weight with at least sixty percent attributable to high integrity data source drivers. The baseline item names to be forecast 808 are displayed in the rows and the names of each custom source driver in the columns 809. The forecast source attributing system requires setting the baseline weight 810 for each custom source driver-item pair 811 and the total for all custom source drivers relating to the row must balance and total to 1 indicating 100%.

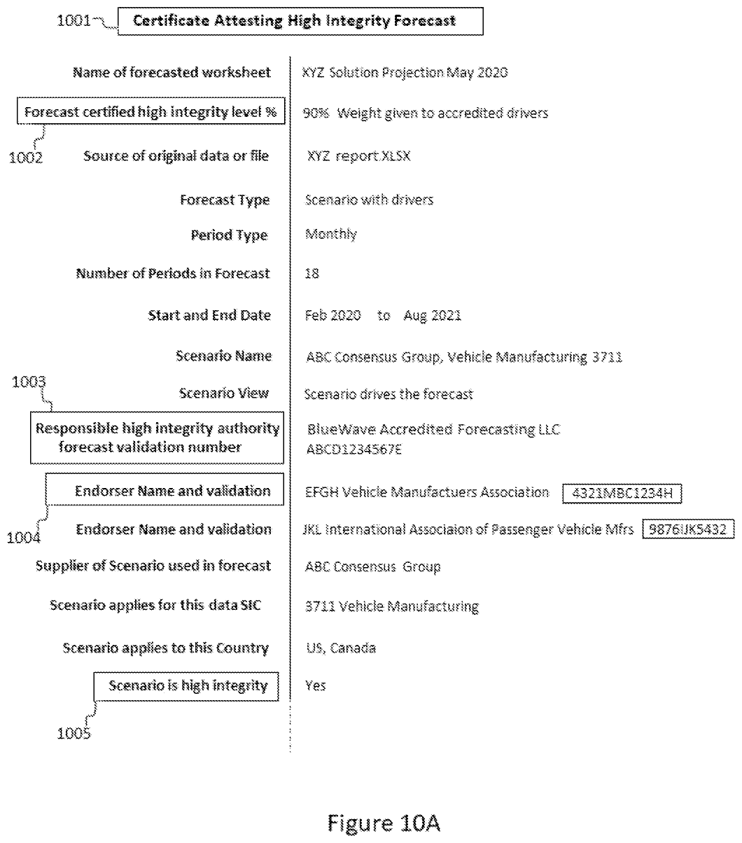

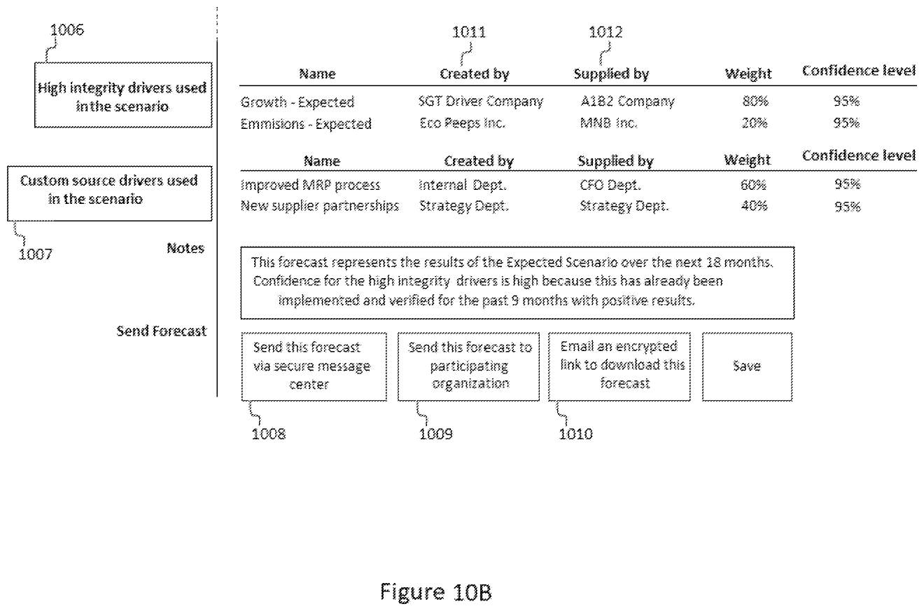

FIG. 10A illustrates a further drill-down by baseline item 901 where the drivers in FIG. 8A are displayed in the rows 902, and the total of these drivers 903 adding to 1 to represent 100%. The second column 905 comes from the high integrity drivers seen in FIG. 8A. The weight of individual periods 907 can be changed from the baseline value 908 to another value with the proviso that the changed values must add to 1 in the weight total 903. This forecast source attributing system will display the new baseline 906 which is derived from the individual periods in the forecast.

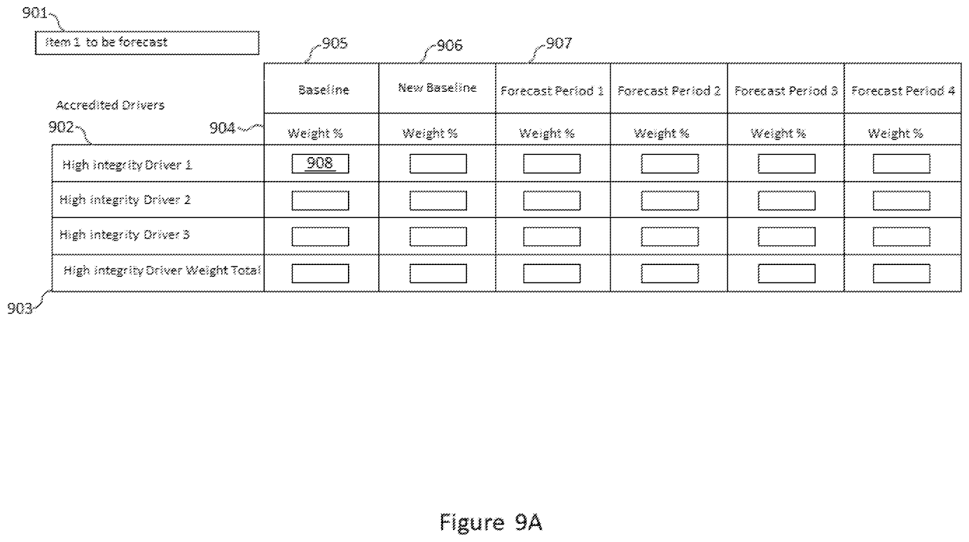

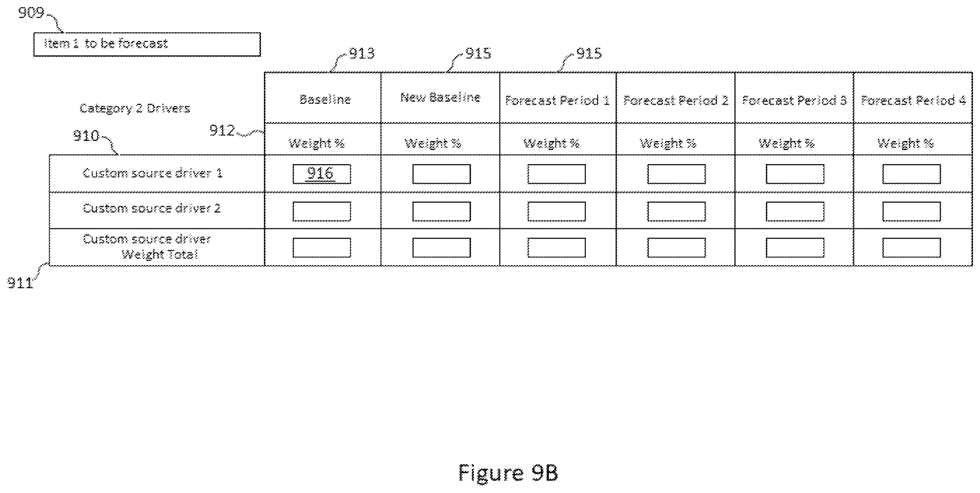

FIG. 9B illustrates a similar application to FIG. 9A with the exception that it pertains to Category custom source drivers. The baseline item 909 where the drivers in FIG. 8B are displayed in the rows 910, and the total of these drivers 911 adding to 1 to represent 100%. The second column titled baseline 913 comes from the Category custom source drivers seen in FIG. 8B. The weight of individual periods 915 can be changed from the baseline value 916 to another value with the proviso that the all the values after the changes have been made must add to 1 in the weight total 911. This forecast source attributing system will display the new baseline 915 which is derived from the individual periods in the forecast.

FIG. 10A illustrates evidence of the forecast details displayed in the certificate of high integrity forecast 1001. The level of accreditation 1002 which is the result of the weight given to high integrity drivers, the name and unique validation number of the responsible certifying authority of the forecast 1003, the name and validation number of the endorser 1004 of the supplier of the high integrity forecast data in the forecast, and the reliability status of the scenario 1005 in terms of it being an high integrity scenario for a particular data source type.

FIG. 10B is a continuation of the information from FIG. 10A, and evidence supporting the high integrity drivers 1006 within the high integrity scenario are displayed with pertinent details and the same driver information is displayed for the custom source drivers 1007. Additional information is displayed in the notes and the forecast source attributing system provides the option to send the forecast via the secure message center 1008 or to send directly to the an authorized institution who requested the forecast 1009 or to email a forecast source attributing system generated encrypted link 1010 to a stakeholder to view the forecast.

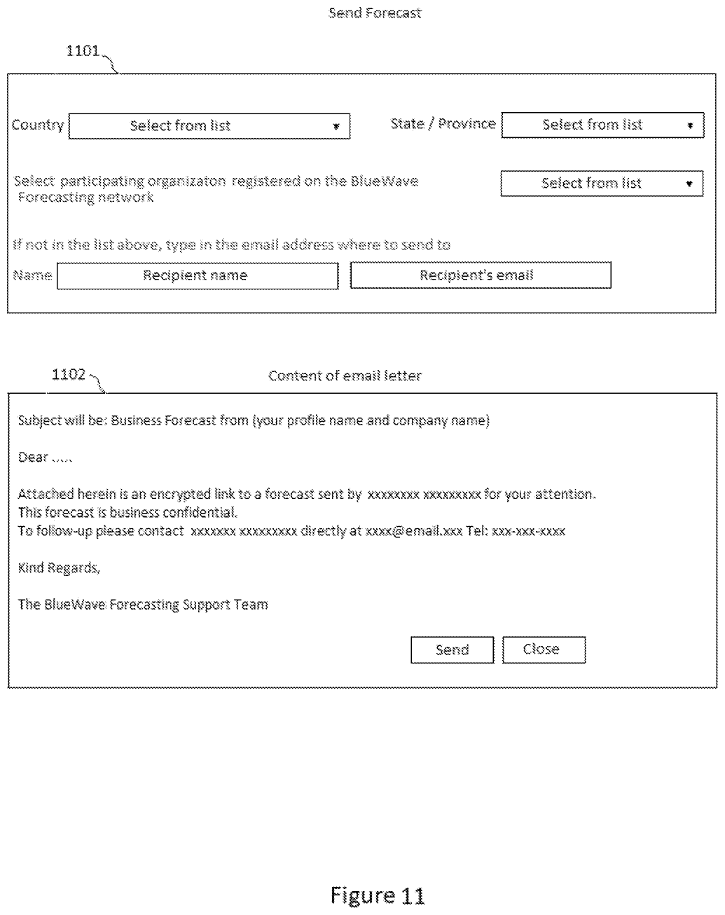

FIG. 11 illustrates the forecast source attributing system options in the process to send encrypted link access to the forecast 1101 and displays an example of the text content 1102 of the email and forecast source attributing system generated letter.

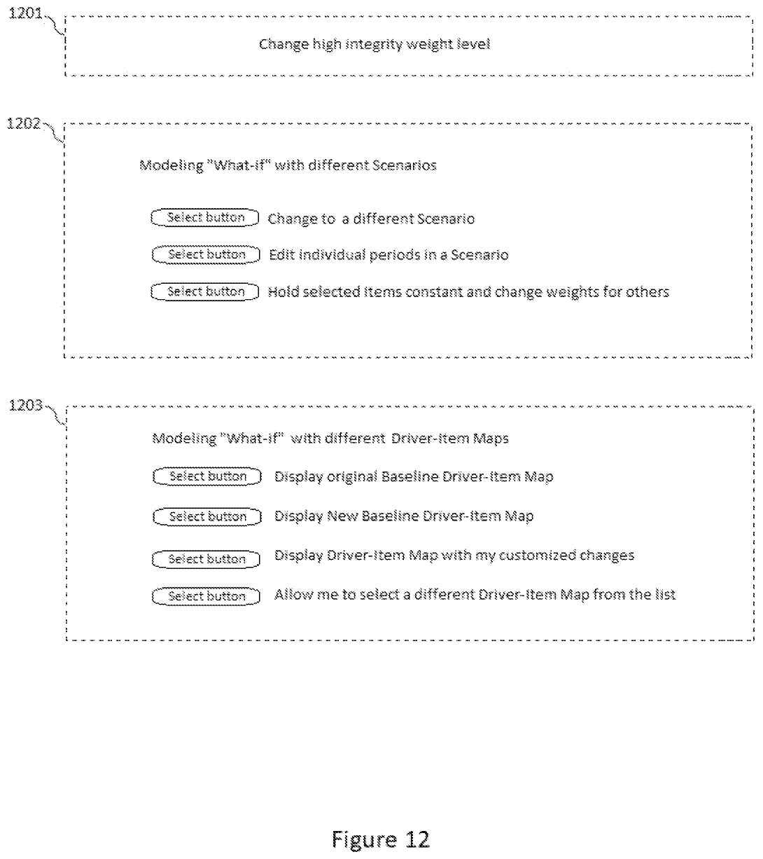

FIG. 12 illustrates the editing options including modelling “what-if” options provided by the forecast source attributing system. The forecast source attributing system provides the receiver of a forecast with access to these same modelling options. The high integrity weight level 1201 can be changed. Additionally 1202, a different scenario can be selected and applied to the baseline data and viewed, as well as editing driver values and weights in individual periods, and also viewing different driver-item maps to see the effect in the forecast.

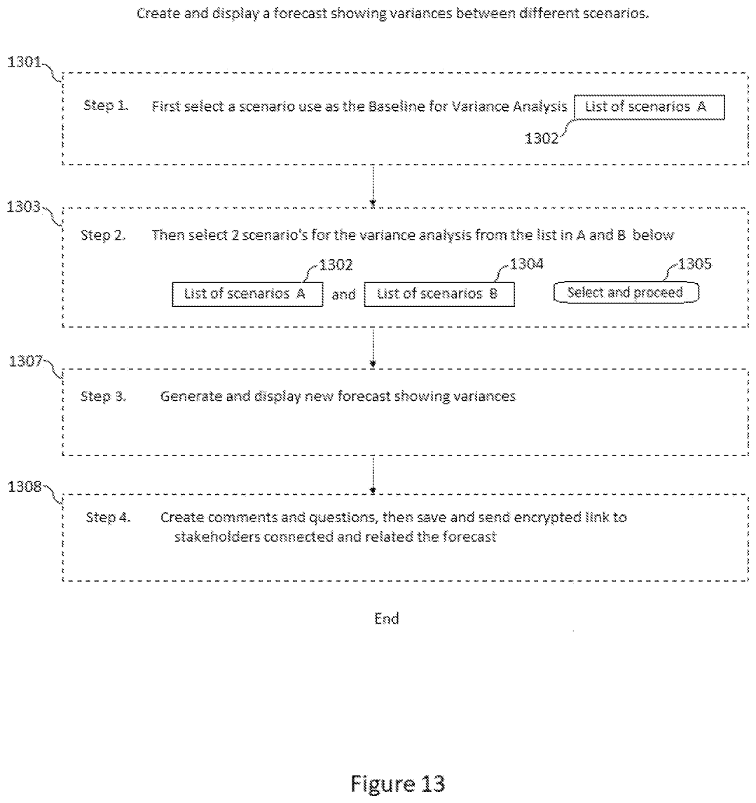

FIG. 13 illustrates variance analysis with variances between different scenarios via the variance analysis viewer in the forecast source attributing system, and the steps in this process. In Step 1, 1301 a scenario 1302 to use as the forecast baseline for comparison is selected, and this is followed to the second step 1303 where a second scenario is selected to compare to the baseline scenario from a list of scenarios 1304. The button 1305 when pressed will guide the forecast source attributing system to proceed to the third step 1306 where the forecast source attributing system will generate the forecast that is based upon the selected scenario and driver-item map but that now also displays the selected variance information.

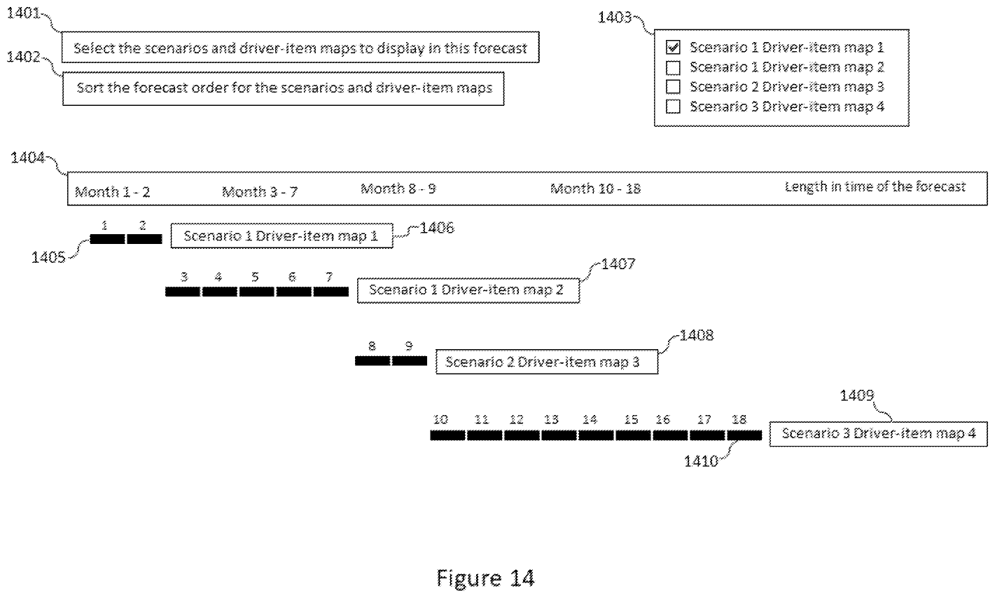

FIG. 14 illustrates the method where multiple scenarios and corresponding multiple driver-item maps can be incorporated to generate a single forecast. The scenarios are therefore stacked up and selection of a scenario with driver-item map 1401 and assignment of a place 1402 in the time period of when to apply it in the forecast. The selections made in 1401 and 1401 will display in the list 1403 and selecting one or more of these scenario driver-item maps and via the application of a date selector will cause the forecast source attributing system to assign time periods for which to apply each of the sequenced scenario driver-item maps, with the selection being depicted along a timeline 1404 and with each period 1405 depicted as a bar and the corresponding label for the scenario driver-item map 1406, 1407, 1408 and 1409 being the respective labels adjacent to the time period each represents, and the final time period 1410 being the last period in the forecast. When the forecast is generated the computerized algorithm will utilize the drivers in each scenario driver-item map according the correct time sequence.

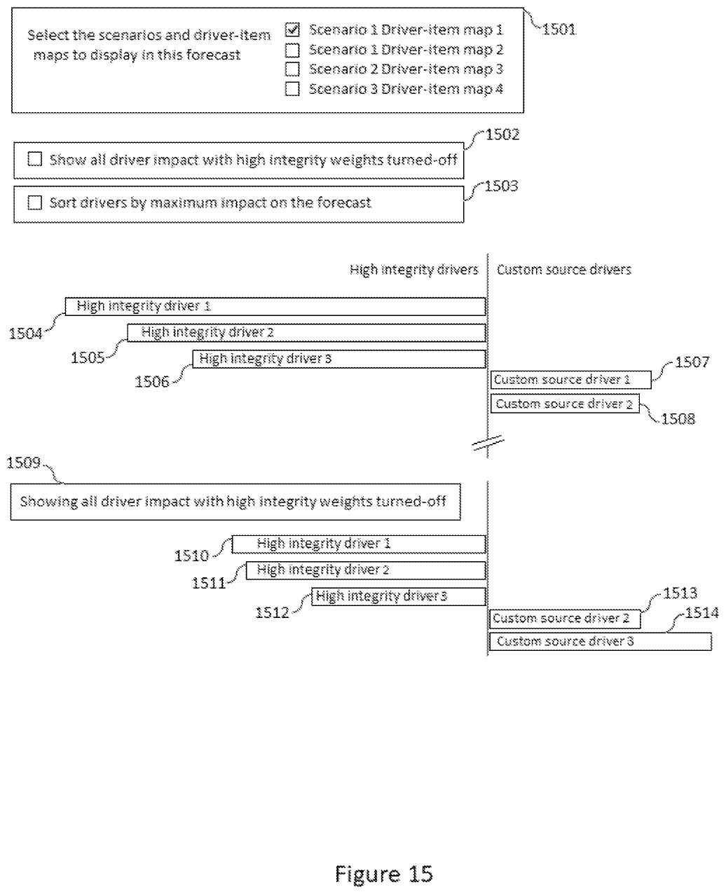

FIG. 15 illustrates the impact interface effect of each driver in a forecast according to the weight of the given to the high integrity and Category custom source sections of the forecast and the weight allocated to each driver. The driver impact can be viewed by selecting one or more from the list in 1501. As selections from the checkboxes or other selection device are made, the drivers will display in the tornado style chart 1504-1514 with the length of the bar of a driver representing the weight and thus the impact of the driver on the outcome of the forecast, The high integrity weights may turned-off 1502 in the scenario with resulting effect illustrated in the driver bars 1509-1514, and also the drivers may also be sorted by their respective impact on the forecast 1503.

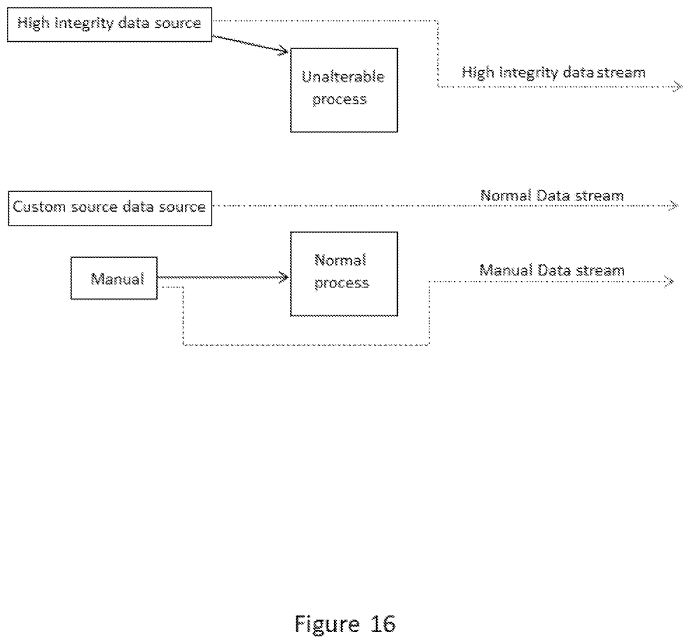

FIG. 16 Illustrates the source, restriction and flow of both high integrity data source and customer data source illustrating that the high integrity data source is locked to access and cannot be altered once it is in the database of the forecast source attributing system. The custom source data numbers can be altered within the constraints of the forecast source attributing system process and user interface.

### DETAILED DESCRIPTION OF THE PREFERRED EMBODIMENTS

Medium to long-term forecasting is fraught with technical difficulty and obstacles which lead to both reliability and believability of a forecast. Compounding this is the uncertainty about the integrity of the forecast itself in that the formulas, weights, baseline data, percentage-level high integrity, and driver values are as the intended by creator of the forecast and have not been altered without permission.

The importance to third-party accreditation and endorsement by relevant skilled professionals of a forecast is significant because it provides credibility from a non-interested data source. A forecaster that has an interest in the forecast e.g. to use the forecast to obtain some benefit usually has credibility issues despite being a skilled professional. However if the drivers data i.e. the period values are developed by professional and recognized data source type experts, then the driver can be high integrity by these professionals and experts can obtain endorsement by the relevant data source type association, and then the high integrity status will be affirmed. To keep the integrity of any data intact and unaltered and therefore an encrypted mechanism within the forecast system is critical for a high integrity forecast and this logic underpins the high integrity aspects of the invention and claims herein.

The process of encryption control, the methods and user interfaces of the invention keep the integrity of the values in the high integrity drivers and scenarios intact in a manner that is highly secure and cannot be breached and keeps the integrity of the forecast intact and the forecast source attributing system secure from unauthorized manipulation of methods, formulas and data traceability.

Scenarios and drivers, both high integrity and custom source are received from data suppliers with expertise in their subject matter, stored in the forecast source attributing system database where they will be displayed in a list that can be organized in various ways by standard data classification codes (for example vegetables, demographics (births, deaths, deaths from Covid-19)) and can be sold as scenario with drivers or drivers alone for application of a forecast related to one or more SIC or NAIC codes.

The properties in and related to a driver are name, high integrity yes or no, data source types, standard code to which it applies, location (for example the country and state or province) to which it is connected, the start date and end date and number of forecast periods, type of period e.g. daily, weekly, monthly, quarterly, semi-annual, annual, the value type e.g. percent, percent change or number, name of responsible expert professional who created it, name of data supplier who is making it available on the forecast source attributing system.

The forecast source attributing system is designed to keep the integrity of the forecasting methods secure from unauthorized alteration, which incorporates encryption technology to keep the data input and data output integrity secure from external unauthorized threats of viewing and altering without permission.

A scenario is comprised of forecast drivers arranged in two sections; one section is traceable to high integrity sources of data and the other that is custom source sources of data input. Custom source data is traceable, but the provider of this data is not required to be certified as an expert professional, and they can be logged into the system having the role of report creator.

FIG. 3 introduces and illustrates the following ideas:

The first is the process of setting the level of professional accreditation that will ultimately vest on the forecast. Therefore, the forecast that is generated will be high integrity. Additionally, all the items that go into shaping the forecast will be available on a signed certificate report that can be part of the forecast;

The second process is the creation of a scenario by selecting from a list of professionally high integrity drivers applied to a data source type and thus allowing attribution of accreditation and the process, rules and procedures associated with accreditation of a scenario and driver.

Third is to attach recognized data source type endorsement to a scenario and a driver. For example an association may endorse a scenario or a driver as being applicable to a particular situation. So, an association may endorse a particular source of a scenario or a particular driver. In this way an association may indicated that the supplier of the data is professional and consistently produces credible data that many in the data source type be rely upon. For the endorsement to be regarded as credible, it needs to be recognized as having been signed and thus providing verification that prevents the input data and the process from being altered can be quickly verified by the endorsing organization that it has indeed issued the endorsement as evidenced by the validation number(e.g. electronics hash signature) on the certificate FIG. 10A 1003 and 1004.

The outcome is a auditable validated high integrity scenario forecast that the forecast source attributing system generates from baseline data to produce a high integrity forecast with full traceability of all data inputs and strong encryption protecting the integrity of the forecast source attributing system, data and generated forecast. Effectively for the first time, a comprehensive forecast tool and system can offer the function of a verifiable high integrity forecast, based upon high integrity scenario, which is based up high integrity drivers, which come directly from a data source who is recognized data source type as expert and professional and qualified to supply high integrity scenario and drivers.

The user will import baseline data into the forecast source attributing system. Baseline data can be wide in it is type and application. The data can be imported via a database, database warehouse, Cloud storage, accounting system, and spreadsheets such as Excel.

The forecast source attributing system provides the method for each driver of an item to be assigned its own weight for both the intersection and for individual periods in the forecast which allows the forecast to be more acutely calibrated for seasonality and events and improves reliability of the forecast.

The driver map process begins with requiring a scenario to be selected with drivers that align to the baseline data to be forecast. Once the scenario is selected, the forecast source attributing system can display a window that is populated with the high integrity drivers inside the scenario.

The high integrity driver's section of the scenario can be weighted to assign the level of accreditation that will be attributed to the forecast when it is generated. For example, it may be specified that the desired target level of high integrity for the forecast should to be at least seventy percent. Then the method can formulaically weight the group of high integrity drivers in the scenario at 70% and the bucket of custom source drivers at 30%. When the forecast is generated, it will have been influenced 70% by drivers that are high integrity meaning that it can be regarded as a high integrity forecast. The status of high integrity can only be guaranteed if the forecast source attributing system is secure and closed to intrusion and cannot be manipulated and thus keeping the integrity of the algorithms and data in authentic state. When a forecast is generated by one of high integrity source systems it is written to a distributed ledger (for example a blockchain) on all of the high integrity source system computer, and goes through a blockchain simple proof of work scenario. If enough member of the block chain vote to admit a new high integrity source member then that accredit source member can become part of the distributed ledger process. forecast source attributing system

The process to begin to set and to create a driver-item map and set all the weights for each driver-item at high baseline level, as well as at a more granular per period level, through a user interface in FIG. 6 and when the system receives a click to calibrate the per period weight 607 for an item. then the system can open a window with features similar to those illustrates in FIG. 7. The granular-level of weight setting method with intervals being at each period in a forecast can allow customizations to improve the reliability of forecast periods within time-sensitive forecasts because specific events at points in time e.g. seasonality will not only be calculated but will be calibrated as well via the mapping and weighting user interface.

The concepts, notion, processes and user interface as illustrated in FIG. 7, FIGS. 8A, 8B, 9A and B in the forecast source attributing system provide input options to individualize the process of linking and weight-setting of each driver-item pair and setting the prior period to reference for both the driver and the item to be projected to generate a forecast.

In addition to the elements embodied in the forecasting methods presented above, the forecast source attributing system user interface displays the expected effect of the drivers in a scenario by the scenario name and description. Thus the same driver names can be packaged into a scenario but different scenarios (e.g. expected, optimistic and pessimistic views of the same drivers) created by four methods, namely (i) by ascribing different weights to the category of high integrity drivers, (ii) then also setting different baseline weights to all drivers in the scenario, (iii) changing the original weight baseline by setting different weights in the driver-item pair periods, (iv) by ascribing different values in each period of the drivers in the scenario i.e. with different values of the forecast from the name and description of the scenario. This introduces the feature of an high integrity scenario and high integrity drivers and apply this in a practical manner to the methods and user interface design to generate a forecast, and to use all four options listed above in this paragraph and provide a user interface to implement the described process.

To generate a forecast the system maps the items with the appropriate amount of weight that reflects the role of that driver under a particular scenario. The system requires a methodical process with appropriate user interface tools to implement it. With the system's ability to finesse the influence and effect of all drivers' baseline weight, driver individual weight, driver period values, and high integrity weight, upon the baseline item to be forecast, it is possible for the generated forecast to be reliable over the different time periods and reflect seasonality and real-world effects that impact the organization is being generated. This enables real-world practical effects of source data to be represented in a forecast that is generated in the forecast source attributing system.

The screen that is displayed in FIG. 7 illustrates the first step in the creation of a driver-item map that is created from a scenario. The combo box in 716 provides the selection for a historical reference point for the item that is to be projected from a list with options such prior month, prior year, prior quarter, average for the last summer season and so on. I addition and in similar fashion to the item having a reference point from it's own historical data, the forecast source attributing system provides for a driver to also have its own historical reference point selection 710 to use in calculation of the factor to apply to the baseline item when generating the forecast.

The notion of a driver-item map with all the weight feature settings that impact the forecast, is unique in this user interface and process to the forecast source attributing system. The high integrity driver forecast calculation with the mathematical relationships between the high integrity scenario, high integrity drivers and Category custom source drivers and the baseline items to be forecast, is set into the forecast source attributing system and is an array of formulas created and certified as appropriate and reliable by professionally certified and registered actuaries and this fixing of actuary accreditation in a formula that is encrypted into a generated forecast with an audit trail that is part of the forecast certification and cannot be altered.

The user interface that provides the option for user to select the period of prior reference when forecasting an individual baseline item 709 in FIG. 7 enables the forecast source attributing system to provide user with a choice or to apply a unauthorized modification method to a group of drivers. The problem with this is that traditional approach is that inaccuracy is created because individual baseline items to be forecast are more suited each to their own periods in time back reference. For example number of items can be compared with a prior year to account for seasonal differences, whereas for an exchange rate, it might be more suitable to reference the prior month, and for a costs it might be better to reference the average cost in a quarter period in the previous year. These are important variables that can influence the forecast outcomes of the baseline item being forecast.

Segmentation of scenarios and drivers into the categories of high integrity and custom source is important that the forecast source attributing system method and user interface. The forecast source attributing system filters and assigns drivers and scenarios imported into either high integrity or custom source based upon settings designed to screen and verify the authenticity and integrity of the source of the driver and scenario data as part of the importing process.

To create a new scenario, the forecast source attributing system provides an option to select the level of accreditation for the scenario e.g. 80% high integrity. The forecast source attributing system then displays the relevant high integrity drivers related to the data source type that has been selected.

A user working though the mapping process in FIG. 8A is presented with an option to display and change the weight given to the high integrity drivers 801 and unless this is altered, the original weight selected when the scenario was first created, will apply when running the forecast algorithm. The advantage of the user interface that separates driver categories and working first with high integrity driver category weight and then individual baseline driver-item pair weights is that it guides attention to the elements of the forecast that will make the forecast to be high integrity and thus more valuable. The baseline driver-item pair weight 806 is the first step in weighting for the map.

The next step once the baseline driver-item pair map has been completed, is shown in FIG. 9A where one baseline item 901 is displayed with the drivers 902. The baseline value created in FIG. 8A being 806 and the total 805 is carried forward to FIG. 9A in 905, 908 and 903 and this column 907 and the further periods are where edits to the weight of a driver to change it from the baseline to a different value that more accurately reflects expectations of a particular period e.g. for seasonality, expected and known events over the periods in time can be made. Expanding the baseline weight into the granular period level for high integrity drivers and custom integrity drivers is a novel development in the forecasting world and useful to generate more accurate, reliable and credible forecasts.

A high integrity forecast should be considered more reliable because the high integrity drivers used in the forecast follow a process of vetting and tracking and are also secured with encryption.

The forecast source attributing system provides for the setting of a percent level of allocated to high integrity drivers so that custom source drivers can be included in the forecast but their effect is reduced to the amount necessary in order to maintain the highest level of accreditation with high integrity drivers while incorporating the element of local realism as possible in a generated forecast. For example, the forecast source attributing system can generate a forecast that is 70% from sensor derived high integrity data from say satellite image data, or satellite derived ozone levels, or projected temperature reading for the US based on ocean temperature and currents, and the other 30% can be from custom source data that is less robust because it is forecasted and is open to some level of uncertainty and therefore less robust but should be included just at a lesser level of influence.

Because the system generates the forecast that is generated in the forecast source attributing system described herein will have followed a strict protocol and process where both the high integrity driver that are included in a scenario and the values of each period in each driver come from verifiable consensus and expert and professional sources and the algorithms are signed-off as appropriate, relevant and reliable, it is possible and appropriate for the licensor and operator of the forecast source attributing system to issue a certification attached to the forecast to verify that it is reliable and good quality that may reasonably be relied upon for certain levels and types of decision-making. The certification attached to the forecast provides assurance that inputs used to generate the forecast have not been altered and this is encrypted by using a strong method that provides confidentiality, integrity, non-repudiation and authentication to the authorized viewers and users of a forecast. This this the type of secure encryption synchronous and asynchronous encryption is provided by Blockchain and incorporated in the forecast source attributing system to secure the access, traceability of data and formulas that drive the forecasts in the forecast source attributing system.

The certification of forecast drivers and endorsement attesting the quality and reliability of the suppliers of the drivers and scenarios by at least one verifier professional organization brings credibility to a forecast that is generated by the forecast source attributing system. FIGS. 10A and 10B displays the information that is attached to each high integrity forecast.

Once a forecast is generated in the forecast source attributing system it cannot be changed and the certificate locks-in all the information that went into generating the forecast. Encryption technology is used in the forecast certificate and the forecast source attributing system disables and edits or changes to the forecast. The Certificate of high integrity forecast in the manner provided in the forecast source attributing system is valuable for which a forecaster and stakeholder will be required to pay a fee because it is a costly process to ensure and maintain integrity of scenario and drivers and the forecast source attributing system itself.

The primary receiver of value from the Certificate of high integrity forecast and the forecast itself are the stakeholders in the forecast. The information on the certificate is designed to provide comprehensive detail relating to the creation of the forecast. The level of accreditation 1002 in FIG. 10A is important and is cross-verified 1005, and the audit of integrity 1003, 1004 in FIG. 10A and 1006 in FIG. 10B show the authorized responsible organization who is certifying the forecast and the endorser of which there is always by rule, at least one endorser related to an high integrity forecast. The drivers in a forecast might also be available under different scenarios e.g. expected, optimistic and pessimistic, and these roll-up into different scenarios, and so the scenario name and scenario view on the certificate is important information. The responsible name and validation number 1003 and 1004 is important in that the user is able to contact the validating organization to verify it's knowledge and endorsement of their role in the forecast. The traceability again supports the credibility and value of the forecast generated by the forecast source attributing system to stakeholders who will use the forecast.

The information relating to the creator 1011 and supplier 1012 of each driver together with the weight and confidence level especially pertaining to high integrity drivers illustrated in FIG. 10B 1006 is particularly important to understand the composition of the forecast created by the forecast source attributing system. In the forecast source attributing system the source of the driver is identified with created by 1011 and the supplied by 1012 may also be the creator although this might just be the facilitator of the data into the forecast source attributing system. Once created, the driver data is kept secured with encryption upon its dissemination to the forecast source attributing system database and this provides the important process of traceability. The entire body of data presented in FIGS. 10A and 10B is the manner in which the forecast source attributing system communicates the composition relating to each high integrity forecast. The process of security and protection is continuous until the end and links to access the forecast are encrypted and the forecast and all information pertaining thereto and non-alterable once created.

Encrypted protection of the forecast and the link to access it is embedded in the forecast source attributing system and this technology is included in the methods and user interface tools of this invention. The methods of traceability, encryption and protection of driver, scenario, formulas and system are not found in available forecast systems and there is no such thing as a forecast source attributing system and no reference to this in other patents or textbooks. The encryption technology used e.g. Blockchain provides the following features to an high integrity and high integrity custom source forecast generated by the forecast source attributing system: (i) it ensures the forecast is confidential and cannot be viewed or opened by unauthorized persons, (ii) the forecast will retain complete integrity and once created cannot be changed without traceable permission, (iii) that the sender of the forecast and the receiver of the forecast cannot repudiate that it was sent or received, and (iv) that the source of the forecast driver data and the forecast itself can be authenticated e.g. that a driver actually driver-item come intact from the named supplier and that the forecast actually did come from the responsible certifying authority on the certificate, and that the endorsers actually did give their consent for their validation as listed by their respective validation numbers on the certificate.

A benefit of the strong encryption method used within the forecast source attributing system is that because the audit trail of the data and settings is so comprehensive, a significant part of the analysis of a forecast can be automated to seek out the metrics and variables that an analyst will require to make decisions that are based on the forecast and different forecast scenarios.

The inventions embedded within the forecast source attributing system provides the means to make secure access to the forecast available to third parties and this method and user interface is novel to the forecast source attributing system. FIG. 10B displays the sending 1008, 1009, 1010 encrypted access with links within emails, internal business message systems, SMS text (short message service) and other available systems that work on the mobile text, data or other communication mechanism and device, to provide access to the forecast for which access is given.

included in the methods referred to in the previous paragraph, is the user interface FIG. 11 that the forecast source attributing system provides forecast source attributing system the tools to search for a select an organization that has been pre-screened for Security and authenticity and is registered on the forecast source attributing system. Thus the forecast source attributing system receives input and instruction to send the forecast to a bank which is registered on the forecast source attributing system. The forecast source attributing system provides for entry of email address of an intended recipient and the forecast source attributing system will send a message that contains an encrypted link to that recipient email address. If the recipient organization is not registered on the forecast source attributing system there will be a further verification task and if successful, the recipient will be given access option to the forecast source attributing system.

The forecast source attributing system offers recipients of an encrypted link to access a secure forecast, the means to access the forecast and perform “what-if” modelling to alter the value of the variables that were used to generate the forecast. This feature is novel o the world of forecasting and the feature is accessed via a user interface dashboard window FIG. 12 that displays a menu of choices from which either an authorized recipient of the forecast with encrypted access to this “what-if” modelling functionality can use. It is common for the recipient of a forecast to need information on what the forecast will look like if certain of the variables are tweaked or changed. The forecast source attributing system provides the methods and user interface to independently perform “what-if” analysis and to save the result and make it available to the creator of the forecast. The original forecast is kept intact and a clone which is an identical copy of the active forecast is provided in the forecast source attributing system with unrestricted access for such “what-if” modelling functionality.

The modeler i.e. the person doing the “what-if” modelling in the forecast source attributing system is provided with the facility via the user interface to change the weight of the high integrity section as a whole 801 in FIG. 8A, as well as to change the baseline weights of the driver-item pair in the driver-item map 802-806, and also able to change the weight of individual periods FIG. 9A 902, 907 in the table. All of these changes will have some impact on the result of the forecast and after making edits to the existing setting and data, the modeler will run the forecast algorithms again by pressing a button to generate a new forecast and will see the results of a new forecast. The forecast source attributing system can also display variances against any other scenario driver-item map. The “what-if” modelling in the unique manner of the forecast source attributing system is an innovate and non-obvious way to stress-test different driver-item maps and driver-item pair that are driven off different high integrity level scenarios.

After the modeler saves the forecast, the forecast source attributing system will generate a certificate as depicted in FIGS. 10A and 10B and the forecast can be shared and sent by the modeler to a third party.

Variance analysis is quite common in forecasts and the forecast source attributing system claims novelty relating the variance analysis in a specified area only, and this relates to the variances between high integrity scenarios. The difference in this forecast source attributing system is that scenarios can be high integrity and weighted and the via the drivers and this is novel to the world of forecasting and forecast source attributing systems. The usefulness of this type of variance analysis cannot be overstated because it provides an efficient and powerful method to analyze within a forecast, the difference between high integrity and custom source scenarios, scenarios with different percent levels of accreditation, drivers, and driver-item maps.

The invention components can be modular software components that are part of the claims in this application and can be integrated into or sit alongside as clip-in support to bolster any driver-based forecast source attributing system provided by other vendors to make the unique features of this invention available to those systems.

In addition to a single scenario forecast, the forecast source attributing system also provides the user interface and method depicted in FIG. 14 to include more than one scenario driver-item maps. This is useful where multiple scenarios apply to different periods in time horizon of the forecast. This function and feature would be useful when making forecasts that might include seasonality and other known or planned for events and would typically involve full costs longer than six months and up to 36 months in time. The user interface design provides a convenient method for a use it to quickly see the high-level overview of how scenarios are allocated within a forecast.

The forecast source attributing system provides the methods and user interface to effect and view the effects of changing the target percent level of accreditation of a scenario because such high integrity level would typically have a significant dilution effect on the contribution of custom source drivers in the forecast. The method and user interface to view, select and change accreditation and weights is illustrated in FIG. 15 where the tornado type chart illustrates the high integrity section 1504 to 1508 drivers there the high integrity drivers Can be seen to carry significantly more weight than the Category custom source drivers and therefore their impact on the forecast will be significantly greater. However, in some instances a forecast source attributing system operator might want to uncheck the high integrity section and disallow any weight advantage to any drivers for any of these scenario driver-item maps, and this selection would be made from the list 1501 as shown. If the operator wishes to view the forecast results by removing the weight given to drivers within an high integrity scenario, then the checkbox 1502 would unchecked. The drivers can also be shown in a raw contribution sort order if the user selected the option 1503 to sort the drivers by their maximum impact on the forecast.

(e) The authorization shall read as follows:

A portion of the disclosure of this patent document contains material which is subject to (copyright or mask work) protection, The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

The invention claimed is:

1. A secure forecasting system on a computer comprising:
a computer with processor, memory, user interface displays, methods and network connectivity where the computer is running software that has:
at least one high integrity source with a high integrity number for a time period, where the time period is in the future,
a target integrity percent for the forecast to be generated,
at least one custom data source driver with a custom number for the time period,
a target custom percent and where the target custom percent is one minus the target high integrity percent,
a forecasted number calculated for the time period where calculating the forecasted number includes multiplying the high integrity number by the target integrity percent and includes multiplying the target custom percent by the custom number,
a high integrity data provider role, where the high integrity data provider role can enter the high integrity number,
a report creator role where and the report creator role is not authorized to enter or modify the high integrity data, and the report creator role is authorized to modify the custom number.

2. A secure forecasting system on a computer comprising:
a computer with processor, memory, user interface, and network connectivity where the computer is running software that has:
at least one high integrity source with a high integrity number for a time period, and
a target integrity percent,
calculating a forecasted number for the time period where calculating the forecasted number includes multiplying the high integrity number by the target integrity percent.

3. The secure forecasting system as claimed in claim 2 where the time period is in the future.

4. The secure forecasting system as claimed in claim 2 where the system has a report creator role and a high integrity provider role, and only the high integrity provider role can enter the high integrity number, and the report creator role is not authorized to modify the high integrity data.

5. The secure forecasting system as claimed in claim 2 where the system further includes
at least one custom data source with a custom number value for the time period,
a target custom percent and
where calculating the forecasted number includes multiplying the target custom percent by the custom number.

6. The secure forecasting system as claimed in claim 5 where the time period is in the future.

7. The method in claim 1, where a scenario that drives the baseline data to be forecast can be categorized as an high integrity scenario because it has met the rules of accreditation and control in the forecast source attributing system, and where the scenario can include high integrity and custom source driver that is relevant to the scenario and weighted less than high integrity drivers in the scenario and this adherence to the forecast source attributing system rules to meet and maintain high integrity status is protected by Blockchain encryption technology and cannot be altered and an high integrity scenario therefore remains authenticity as high integrity;

8. The method where the composite values of a driver over the period range of the forecast equate to a driver scenario and that because data characterizes a driver even a single change to the data value of one period can change that driver scenario into a different scenario characterizing that driver and therefore a different composite scenario;

9. The driver-item pair method where drivers are paired to baseline data items which are the items that a user wishes to forecast and each driver-item pair is weighted relative to the other drivers in the scenario map;

10. The method in claim 9 where the baseline driver-item pair weight are expanded to display all the forecast periods of the driver and provide edit access to the user to change the weight in any period so as to reflect seasonality and to better calibrate real-life expected events;

11. The method in claim 9 where the driver-item pair reference can for calculation purposes be selected to point to a previous period such as previous month, previous year, so as to represent the appropriate point the calculation of the forecast;

12. The method to provide a Blockchain encrypted tamperproof certificate that locks to the forecast and verifies the integrity of the forecast and where the certificate lists the drivers, weights, scenario, influence factor and risk of each driver, applicable industry, names of suppliers of the drivers and creator of the scenario, list of endorsers, and access to the actual locked forecast;

12. od relating to claim 12 where the risk of each driver has rolling updates and flags be delta in forecast risk on the certificate;

14. The Blockchain method to encrypt the forecast information to make it tamper-proof and to send and encrypted link to an intended recipient who may view the forecast, and where the initiator of the forecast can be a bank who requires a loan application to be supplemented by an high integrity forecast and the Blockchain encryption method ensures the integrity of the forecast in terms of confidentiality, non-repudiation and authentication properties;

15. The secure forecasting system as claimed in claim 5 where the target custom percent is one minus the target high integrity percent.

16. The secure forecasting system as claimed in claim 5 where the system has a report creator role, and the report creator role is authorized to modify the custom value.

17. The secure forecasting system claimed in claim 8 further including:
an encrypted link, where the encrypted link can view the forecasted number and change a scenario containing a number, target integrity percent and also the baseline and per time period weights attributed to the high integrity and customer data sources thereby performing “what-if” modelling of the forecast.
